(19) United States
(12) Patent Application Publication
(10) Pub. No.: US 2015/0035849 A1
(43) Pub. Date: Feb. 5, 2015

(54) METHOD FOR IMPROVING THE VISUAL QUALITY OF AN IMAGE COVERED BY A SEMI-TRANSPARENT FUNCTIONAL SURFACE

(71) Applicant: SUNPARTNER TECHNOLOGIES, Aix En Provence (FR)

(72) Inventor: Joël Gilbert, Eguilles (FR)

(21) Appl. No.: 14/377,009

(22) PCT Filed: Feb. 14, 2013
(86) PCT No.: PCT/FR2013/000042

§ 371 Date: Aug. 6, 2014

(30) Foreign Application Priority Data
Feb. 6, 2012 (FR) 12 00330

(51) Int. Cl. G06T 5/00

(52) U.S. Cl. CPC G06T 5/008; G06T 2210/62
USPC 345/592

(57) ABSTRACT

This invention describes a method for improving the visual rendering of an image when said image is placed behind a semi-transparent functional surface. The method consists of modifying certain features of the original image, in particular the brightness, contrast, gamma and colour saturation thereof, in such a way that the visual rendering of the image modified in this way and placed behind the semi-transparent functional surface is closer to the rendering of the original image when said image is seen alone, without the semi-transparent functional surface.

The present invention relates to a method for improving the visual quality of images, printed or digital, that are covered by a semi-transparent functional surface, such as for example a photovoltaic film or a touch-sensitive surface (Touch Screen), or any other functional surface placed in front of an image and which is not totally transparent to visible light.

### PRIOR ART

Semi-transparent functional surfaces placed on the surface of an image, such as photovoltaic films for example, generally use components that are not totally transparent and that are either included in the material of the surface itself, or dispersed over the latter in order to create spaces of total transparency between the components. The luminosity of the image that is perceived by an observer through these semi-transparent surfaces is then a function of the level of transparency of the functional surface. As there is every advantage to having as much luminosity as possible, an attempt is made to increase the transparency of functional surfaces. But this is often achieved to the detriment of the functionalities of this surface.

Thus, for example, semi-transparent photovoltaic films are composed of opaque photovoltaic cells, dispersed in the form of parallel strips separated by spaces of transparencies, so that the ratio of the surface of the opaque cells to the surface of the transparent spaces determines the electrical power available. Thus, wishing to increase the electrical power of the semi-transparent photovoltaic film requires an increase in the density of photovoltaic cells at the surface of the film and therefore a reduction in transparency.

This example does indeed show that the performance of semi-transparent functional surfaces arranged on images is often a function of the degradation of the luminosity of the image that is accepted by the observer. This compromise between functional performance and image luminosity is subjective since it depends on variable parameters such as the features of the image, the ambient luminosity and the visual perception of the observer.

### AIM OF THE INVENTION

The term “functional surface” is defined here as a surface, rigid or flexible, not totally transparent to visible light, and provided with electrical, electronic, mechanical or optical functionalities.

The term “image” includes all types of images, including images printed on all types of media, electronic images composed of backlit pixels or non-backlit pixels that therefore use ambient light, and semi-transparent pixels optionally arranged on reflective surfaces. This term “image” also includes the surface of any “object”, the surface of which can be of any shape.

The arrangement of a functional surface as defined on an image provokes a reduction in the luminosity of said image.

The aim of the invention is to increase the luminosity of the image, and therefore its visual quality, while preserving the performance of the functional surface.

Another aim of the invention consists, correlatively, in making it possible to enhance the performance of the functional surface while preserving most of the visual quality of the image.

### SUMMARY OF THE INVENTION

The main subject of the invention is a method for improving the visual rendition of an original image intended to be placed behind a semi-transparent functional surface, this method being characterized by a processing, notably computer-based, of the original image, consisting in modifying at least one of the visual features of said original image so that the visual rendition of the processed image thus modified, when it is placed behind said semi-transparent functional surface, substantially approaches the visual rendition of the original image when the latter is observed directly without the semi-transparent functional surface.

According to an advantageous embodiment of the processing method, it includes steps consisting in:
displaying an original image not covered by a functional surface and analyzing a set of visual features of said original image;
covering the original image with a semi-transparent functional surface and displaying the original image thus covered to form an image to be processed;
modifying display control parameters of the image to be processed and comparing said visual features of the original image and of the image to be processed;
when, following the modifications of said display control parameters of the image to be processed, the visual features of the original image and of the image thus processed are substantially equal, saving the values of the display control parameters and/or the image thus processed, and displaying the processed image.

Other features of the method according to the invention are detailed in the claims.

The subject of the invention is also a device for displaying an image, notably such as a mobile phone, an electronic journal or book, a computer screen, a technical or scientific monitoring screen, a dashboard or body of a transport vehicle, characterized in that it displays an image processed according to the method in accordance with invention.

The invention also relates to any object, notably such as a tile, a wall of a dwelling or of a building, clothing fabric, and generally any other object, the visual appearance of which is modified using the method according to the invention.

The device according to the invention is composed of an image in front of which a semi-transparent functional surface is positioned. Said semi-transparent functional surface is a plate of crystal glass or organic glass, rigid or flexible, plane or curved, on which electrical, mechanical or optical components have been deposited, such as for example a deposit of silicon, or else a stack of photosensitive thin films such as CIGS (Copper Indium Gallium Selenium) or else organic photovoltaic cells, or else a network of electrical conductors including those with a capacitive effect, and/or an array of micro-lenses or prisms, or polarizing filters.

The semi-transparent functional surface provided with functional components possesses one or more functions from among the following functions: production of photovoltaic energy, touch-sensitive detection, transmission or reception of electromagnetic waves, temperature sensing, microphone, battery for storing electrical energy, detection of metal objects, detection of ionizing radiation, detection of magnetic fields, optical waveguide.

The functional components can be opaque or semi-transparent and/or colored. They are distributed over a part of the plate or over its whole surface while leaving transparency zones through which the exiting light that is emitted by the image leaves. This plate therefore absorbs a part of the light that crosses it which means that the image transmitted through the plate will be seen by an observer as having less luminosity than the original image, i.e. the image seen without the plate that covers it.

In order to compensate for this loss of luminosity, the invention proposes that the original image be modified in order to be seen through the functional surface. This modification consists in varying at least one of its fundamental visual features from among the following: luminosity, over-brightness, contrast, white and color balance, tones, half-tones, color saturation, Gamma percentage, definition, information losses due to a compression of data such as for example the JPEG, GIF, TIFF, BITMAP and PNG modes. This modification of the original image has the aim of partly compensating for the loss of luminosity and the variation of the other parameters of the image that are due to the superimposition of the semi-transparent functional plate.

According to the invention, the modification of the image is preferably done using a computer-based method on the original digital code of the image. This modification can be done using an image processing software program that operates on a computer equipped with a display screen.

For this purpose, the original image and the image being processed are both displayed on a screen so that the observer can compare them visually. The functional surface (real or virtual i.e. simulated on a computer) that possesses the same optical features as the functional surface which will be used in reality is arranged on the original image during modification. The appearance of the image being processed is therefore modified by this simulation that furthermore makes it possible to visually compare it with the original image. One or more parameters of the image being processed are then varied, such as for example its luminosity, its contrast and/or the color saturation in order to determine the most appropriate modifications to be made so that said image resembles the original image as closely as possible. This comparison can be done visually by an observer who is at the controls of the computer, or else by a software program, and/or by optical equipment which allows automated comparative measurements of the visuals of both images.

In summary, this method improves the visual rendition of an image when the latter is placed behind a semi-transparent functional surface. This method is characterized by a computer processing of the original image which notably consists in increasing its luminosity in such a way that the visual rendition of the processed image comes as close as possible to the output of the original image when the latter is observed alone and directly, i.e. without the superimposition of the functional surface.

This method also includes another step which is that of the printing on paper and/or the digital memorization of the features of the image that has been modified, and of the modification parameters used to obtain the final modified image.

This method also includes a computer-based and electronic automation of the modifications that are made to all the images that will then be visualized by the observer, notably in the case of electronic display devices of LCD, LED or OLED type.

For all the images to be processed, the protocol of conversion of an original image into a processed image is a series of digital operations that are made on the computer encoding of the color of a plurality of pixels forming the image (what is called the source code of the original image). These digital operations can be: a multiplication, a division, an addition or a subtraction of fixed or variable values. These digital operations have the aim of modifying the visual features of the pixels, which is indeed the object of this invention. This series of digital operations is carried out by a logic that is known in the language of computing by the names of logic interface, “driver”, conversion protocol, controller, coding or decoding interface, conversion algorithm. Digital image processing operations can be carried out very quickly just before the display of the image which makes it possible to memorize only the original image and not its modified version, which is only stored in a virtual buffer memory, which therefore allows savings of space on the memory storage device of the display device. The logic interface of the image processing takes the form of an “executable file” that is independent and dedicated to these operations. But it can also be integrated as a particular processing module to be integrated into another image processing interface already known, such as for example image encoding interfaces of JPEG, GIF, TIFF, PNG, or ZIP type that have as their main function the compression of the digital data of the images.

The protocol of conversion or processing of the original images into final processed images can be identical for all the images, or can differ between several images of a video sequence.

The adjustment parameters of the processing applied to each original image will be either entered manually, for example for adapting to the optical features of the functional surface, or automatically, for example for adapting to the optical features of the ambient light. In the latter case the features of the ambient light can be measured by said functional surface, which will possess optical sensors known to those skilled in the art, notably photovoltaic cells for measuring the overall intensity and the intensity of each color of the ambient light. This automation of the image processing can also take place over all the images that make up a video sequence.

The image or images thus modified according to the method of the invention can be displayed in display devices such as mobile telephone screens, electronic journals or books, computers, technical or scientific monitoring screens, dashboards in motor vehicles, aircraft, trains, and other transport vehicles, advertising display screens, urban real estate. This will make it possible to improve the display features of the images on these devices with respect to an observer, despite the interposition of a semi-transparent functional surface between the image and the observer.

When the image consists of the surface of an object intended to use the invention, this object can be notably a tile, the wall of a dwelling or of a building, a table, the fabric of an item of clothing, and in a general way any object the visual appearance of which it is possible to vary.

### DESCRIPTION OF THE FIGURES

The invention will now be described in more detail using the 3 indexed figures, namely:

FIG. 1 which shows the principle of superimposing a semi-transparent functional surface (2) on an original image (1);

FIG. 2 which shows the original image (1) which is covered by the semi-transparent functional surface (2);

FIG. 3 which shows the image (3) that has been modified according to the processing method of the invention and which is covered by the functional surface (2).

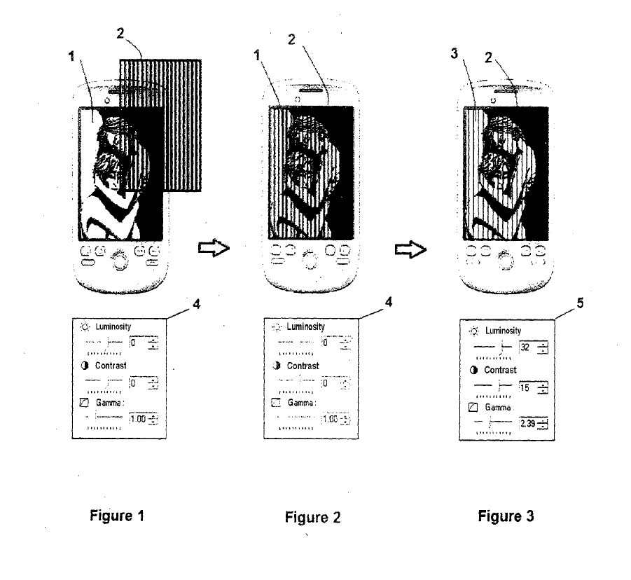

FIG. 1 shows a digital original image (1) displayed on a backlit screen of LCD type, and a semi-transparent functional surface (2) with for example a transparency level of 70%. The original image (1) is represented in black and white to facilitate the reproduction of this descriptive document but said image (1) can also be in color.

The semi-transparent functional surface (2) is represented here in the form of parallel black strips spaced by transparent strips to create a visual impression of transparency, but said functional surface (2) can also have a surface whose transparency is uniform, notably when the dimensions of the functional components are smaller than the separating power of the eye or if the functional surface (2) relies on an optical process to make said functional components invisible. At this stage, the original image (1) is not yet modified and its modification parameters, as schematized in (4) by a series of control cursors, are at zero for the luminosity, zero for the contrast and one for the Gamma value.

We will now refer to FIG. 2 which shows the original image (1) completely covered by the semi-transparent functional surface (2). The result is that the original image (1) appears 30% less luminous because 30% of its luminosity has been absorbed by the functional surface (2), in the scenario when the functional surface has a transparency level of 70%. The original image (1) is not always modified at this stage, and its modification parameters (4) are still at zero for the luminosity, zero for the contrast and one for the Gamma value.

At this stage, the user of the method according to the invention will manually modify and optimize the various modification parameters of the image (luminosity, contrast, Gamma etc.) to regain an aspect similar to the original aspect of the image not covered by the functional surface (2), then save the modified parameters that offer the best result.

Of course, these operations of image comparison and optimization can also be automated and carried out by an appropriate software package capable of comparing the visual rendition of the original image (1) and the visual rendition of the image covered by a functional surface (2), and of optimizing the control parameters (4) of the covered image which minimize the difference of aspect between the uncovered original image (1), and the modified image (3) covered by the functional surface.

Thus, FIG. 3 shows the original image (1) completely covered by the semi-transparent functional surface (2) but this time the features of the image (1) have been modified (5): in the example represented, the luminosity has been increased by 32%, the contrast by 15% and the Gamma coefficient has changed to 2.39 instead of 1. The modified image (3), although covered by said functional surface (2), thus regains a quality of luminosity and an aspect close to the original image (1). In order to simulate the increase in the luminosity of the modified image (3), on FIG. 3, the thicknesses of the black strips of the functional surface (2) have been decreased.

It is furthermore necessary to understand that the digital processing of the original image (1), when the latter is a backlit image, does not modify the power of its backlighting. Indeed, the luminosity of each backlit pixel is increased or reduced by a modification of the transparency of each pixel, for example in the case of LCD technology by a adjustment of the angle of polarization of the polarizing filters. If the functional surface (2) is a photovoltaic film that captures the ambient luminous energy, the increase of the luminosity of the original image (1) will not consume any energy and will therefore not reduce the energy performance of said photovoltaic surface.

A concrete exemplary embodiment will now be described:

An original image (1) must be printed on a square sheet of paper with sides of 1 meter and covered by a photovoltaic plate (2) of glass of the same dimensions and of 4 mm in thickness composed at the surface of a network of parallel strips of photovoltaic thin films of amorphous silicon whose width is of 1 mm and spaced apart by 3 mm. The coverage level of the photovoltaic surface is therefore of 25%, which will produce around 15 watts of electrical power in full sunlight taking account of the conversion yield of the photovoltaic plate.

The observer viewing the original image (1) through the photovoltaic plate (2) will however see the original image (1) with a luminosity that will have decreased by around 25% because of the photovoltaic strips that are a barrier to the light returned by the image.

According to the invention, the original image (1) then undergoes processing, for example computer processing using the control parameters (4), and which consists in increasing its luminosity by 25%, increasing its contrast by 15% in such a way that the image thus modified (3), and thus placed behind the photovoltaic plate (2), is as close as possible to the original image (1) in terms of its visual appearance.

This operation of adjusting the control parameters is carried out by the user on the screen of a computer that displays at once the original image (1) and the image being modified (3). This image being modified (3) is virtually covered by a semi-transparent image composed of black strips of the same dimensions as the photovoltaic plate (2) so that the modifications of luminosity and contrast carried out on the original image (1) make it possible to immediately visualize, by simulation, the visual rendition that will be observed when the real image (3) will be behind the semi-transparent plate (2).

Once the modifications have been carried out, the image (3) is stored in a computer file then printed with the desired dimensions. The active photovoltaic surface (2), having remained the same, will itself produce the same electrical power of 15 watts, but the modified (3) and printed image which is seen through the semi-transparent plate (2) will then resemble the original image (1) more closely than if the latter had not been modified.

Of course, when the original image is not a printed image, but an image displayed on a screen, the display device will display the image as modified after processing, and the appearance of the modified image with the functional surface superimposed onto it will be very close to the appearance of the unprocessed original image, without the functional surface.

### ADVANTAGES OF THE INVENTION

To summarize, the invention meets the goals that have been set, since it makes it possible to increase the visual quality of an original image (1) when the latter is placed behind a semi-transparent functional surface (2).

1. A method for improving the visual rendition of an original image intended to be placed behind a semi-transparent functional surface, this method being characterized by a processing of the original image, which consists in modifying at least one of the visual features of said original image so that the visual rendition of the processed image thus modified, when it is placed behind said semi-transparent functional surface, substantially approaches the visual rendition of the original image when the latter is observed directly without the semi-transparent functional surface.

2. The method as claimed in claim 1, wherein it includes steps consisting in:
displaying an original image not covered by a functional surface and analyzing a set of visual features of said original image;
covering the original image with a semi-transparent functional surface and displaying the original image thus covered to form an image to be processed;
modifying display control parameters of the image to be processed and comparing said visual features of the original image and of the image to be processed;
when the visual features of the original image and of the image to be processed are substantially equal, saving the values of the display control parameters and displaying the processed image with these parameter values.

3. The method as claimed in claim 1 wherein the original image is a printed image or an electronic image composed of backlit pixels or non-backlit pixels, including non-backlit semi-transparent pixels arranged on reflective surfaces, or the surface of an object of any shape.

4. The method as claimed in claim 3, wherein the original image is displayed on a screen of LCD, LED, OLED, plasma, fiber optic or laser projection screen type.

5. The method as claimed in claim 1, wherein the semi-transparent functional surface possesses one or more functions from among the following functions: production of photovoltaic energy, touch-sensitive detection, transmission or reception of electromagnetic waves, temperature sensing, microphone, battery for storing electrical energy, detection of metal objects, detection of ionizing radiation, detection of magnetic fields, optical waveguide.

6. The method as claimed in claim 1, wherein the visual features of said original image liable to be modified are taken from among the following: color spectrum, luminosity, over-brightness, contrast, white and color balance, tones and half-tones, color saturation, Gamma value, definition.

7. The method as claimed in claim 1, wherein the processing of the original image is carried out in a computer-based manner using a software program that displays on a computer screen both the original image and the image to be processed during modification, in front of which said semi-transparent functional surface or a visual simulation of the latter has been arranged.

8. The method as claimed in claim 7, wherein the computer processing of the original image is carried out automatically using electronic and optical equipment that compares the visual features of said original image with those of the image to be processed during modification.

9. The method as claimed in claim 1, wherein it includes a step of storing in a memory the parameters of modifications made to an original image and the re-use of these parameters for modifying and displaying after processing, of the same original image on another display device or on another medium.

10. The method as claimed in claim 1, wherein said computer processing of the images is applied to all the images that make up a visual animation or a video sequence.

11. The method as claimed in claim 1, wherein said computer processing is carried out using a logic interface for modifying the source code of each original image, this logic interface being of controller, algorithm or conversion protocol type.

12. The method as claimed in claim 11, wherein the logic interface for modifying the source code of the original images is incorporated into an image encoding and decoding interface that is part of the display device.

13. The method as claimed in claim 12, wherein the image encoding and decoding interface that is used by the display device is of JPEG, GIF, TIFF,ZIP or PNG type.

14. The method as claimed in claim 11, wherein the conversion protocol is identical for all the images to be processed and/or contains adjustment parameters that are entered manually from a keyboard or automatically from a measurement sensor.

15. The method as claimed in claim 14, wherein the adjustment parameters of the conversion protocol are adapted to the optical features of the functional surface and/or to the optical features of the ambient light.

16. The method as claimed in claim 15, wherein the optical features of the ambient light are measured by the functional surface (2), which possesses optical sensors of photovoltaic cell type for measuring the overall intensity and the intensity of the various colors of the ambient light.

17. A device for displaying an image, notably such as a mobile phone, an electronic journal or book, a computer screen, a technical or scientific monitoring screen, a dashboard or body of a transport vehicle, wherein it displays an image (3) processed according to the method in accordance with claim 1.

18. An object, notably such as a tile, a wall of a dwelling or of a building, a table, clothing fabric, or any other object the visual appearance of which is modified according to the method in accordance with claim 1.
